(19) United States
(12) Patent Application Publication
(10) Pub. No.: US 2023/0023048 A1
(43) Pub. Date: Jan. 26, 2023

(54) MOBILE ENCLOSURE FOR PET SAFETY AND ENJOYMENT

(71) Applicant: Furball Enterprises, LLC, Frederick, MD (US)

(72) Inventors: Maria Laura Canora Jones, Frederick, MD (US); Phillip Bruce Jones, Frederick, MD (US)

(21) Appl. No.: 17/858,394

(22) Filed: Jul. 6, 2022

Related U.S. Application Data
(60) Provisional application No. 63/223,132, filed on Jul. 19, 2021.

(51) Int. Cl. A01K 1/03

(52) U.S. Cl. CPC A01K 1/033

(57) ABSTRACT

The present teachings include mobile enclosures for animals, e.g., pets such as cats. Specifically, the present teachings may include a mobile enclosure device with a housing that can contain an animal therein, and that has a structure suitable for the animal to move around an environment relatively easily while situated within the device. In this manner, the animal can be sheltered within the device, but can remain mobile—e.g., the animal may be able to walk, run, trot, and so on, all while contained within the safety of the mobile enclosure. To this end, a mobile enclosure may include one or more panels providing breathability and visibility, and a relatively lightweight and durable frame that is also relatively flexible, e.g., for increased mobility over and around objects, and/or for storage. Such a device may thus provide safety and security for an animal, e.g., while playing in outdoor environments.

### CROSS-REFERENCE TO RELATED APPLICATIONS

This application claims priority to U.S. Provisional Patent App. No. 63/223,132 filed on Jul. 19, 2021, the entire content of which is hereby incorporated by reference herein.

### FIELD

The present disclosure generally relates to devices, systems, kits, and methods for a mobile enclosure, which may be used for the containment of an animal (e.g., a household pet such as a cat and/or a dog) while providing mobility in a relatively safe environment.

### BACKGROUND

Many animals, such as pets, enjoy being in outdoor environments. However, many outdoor environments present hazards for such animals, especially household pets such as cats and the like. By way of example, domesticated cats that are primarily housed indoors can present risks when allowed to venture outdoors, such as a risk of climbing, a risk of running away, a risk of hiding, a risk from predators, a risk from ingesting a foreign substance, a risk from the elements, a risk posed to humans or other animals, a risk of injury, and so forth. There remains a need for techniques for improved enclosures that allow an animal to be mobile, e.g., so that the animal can be outdoors while mitigating risks associated therewith.

### SUMMARY

The present teachings include mobile enclosures for animals, e.g., pets such as cats. Specifically, the present teachings may include a mobile enclosure device with a housing that can contain an animal therein, and that has a structure suitable for the animal to move around an environment relatively easily while situated within the device. In this manner, the animal can be sheltered within the device, but can remain mobile—e.g., the animal may be able to walk, run, trot, and so on, all while contained within the safety of the mobile enclosure. To this end, a mobile enclosure may include one or more panels providing breathability and visibility, and a relatively lightweight and durable frame that is also relatively flexible, e.g., for increased mobility over and around objects, and/or for storage. Such a device may thus provide safety and security for an animal, e.g., while playing in outdoor environments.

In an aspect, a device disclosed herein may include: a housing configured to contain an animal therein, the housing including a plurality of panels engaged to form a substantially rounded shape having a diameter suitable for containing the animal therein, where at least one of the plurality of panels is gas permeable to allow smells from an external environment to be sensed by the animal from within the housing, and where the housing is at least partially deformable; an opening on the housing that is selectively closable and openable via a fastener, the opening sized and shaped to receive the animal therethrough; a plurality of channels disposed along the housing from a first end of the housing to a second end of the housing; and a stabilizing rod disposed within each of the plurality of channels, where each stabilizing rod is substantially flexible to allow for the housing to be at least partially deformed and to return to the substantially rounded shape.

Implementations may include one or more of the following features. Each stabilizing rod may include a wire including spring steel. One or more of the first end of the housing and the second end of the housing may include a junction where ends of each stabilizing rod are engaged with one another. The junction may include a first cap structurally configured to couple with ends of each stabilizing rod via one or more connection points that selectively permit movement of the ends of each stabilizing rod relative to the first cap, the movement facilitating deformation of the housing that reduces the diameter of the substantially rounded shape thereof. The movement may include rotation such that the one or more connection points include one or more hinges. The first cap may include an actuator movable between a first position and a second position, where, when the actuator is in the first position, the housing is maintained in the substantially rounded shape approximating a sphere, and where, when the actuator is in the second position, the diameter of the housing is reduced such that the housing approximates a cylinder. When the actuator is in the second position, the first cap may at least partially define a void configured to receive at least a portion of material defining one or more of the plurality of panels. Movement of the actuator may include one or more of (i) a rotation about a central axis of the housing and (ii) movement along the central axis of the housing. Movement of the actuator may cause movement of a first annular coupler including one or more connection points along a central axis of the housing, and movement of the first annular coupler may facilitate movement of the ends of each stabilizing rod along the central axis of the housing. The device may further include a second cap disposed at an opposite end of the housing from the first cap, the second cap structurally configured to couple with ends of each stabilizing rod. One or more connection points of the second cap may permit less movement of the ends of each stabilizing rod relative to the second cap compared to the selective movement permitted by one or more connection points of the first cap. The junction may include one or more spring clips connecting an end of a stabilizing rod to another end of another stabilizing rod. Each of the spring clips may be reinforced for stability. Reinforcement of one or more spring clips may include placement of a tape about the one or more spring clips. The tape may include a shrink tape that is melted about one or more spring clips after placement about one or more spring clips. The junction may include at least six ends of the stabilizing rods and at least three spring clips, where each of the at least three spring clips connects at least two of the at least six ends of the stabilizing rods. The device may further include at least six stabilizing rods coupled at junctions disposed at each of the first end of the housing and the second end of the housing. The device may further include at least three stabilizing rods coupled at a junction disposed at one of the first end of the housing or the second end of the housing. The plurality of panels may include at least one or more first panels and one or more second panels, where one or more of the first panels are different than one or more of the second panels. One or more of the first panels may include a first material that is at least partially transparent or translucent, and one or more of the second panels may include a second material that is substantially non-translucent. The first material may be a mesh material, and the second material may be a canvas material. One or more of the first panels and one or more of the second panels may alternate along a circumference of the housing. One or more of the plurality of panels may include a mesh material. The mesh material may be a medium weave breathable mesh material. One or more of the plurality of panels may include a canvas material. The canvas material may be an outdoor heavy-duty grade cotton material. Each of the plurality of panels may be made of a fabric material, and the fabric material and a fabric pattern of the fabric material may be structurally configured to prevent claws of the animal from snagging along the fabric material. The device may further include a handle disposed on the housing. The handle may be formed by one or more of the stabilizing rods. The device may further include a pocket for receiving an accessory therein. The device may further include a tracking device removable and replaceable within the pocket. The device may further include a tracking device on the housing. The device may further include a photoluminescent material on the housing. One or more of the plurality of panels may be made at least partially from the photoluminescent material. The device may further include a tether selectively attachable to the housing. The device may further include one or more markings. One or more of the markings may include identifying information for the animal. The identifying information may include contact information for a user associated with the animal. The device may further include a noise emitter. The noise emitter may include a bell. The device may further include padding disposed along one or more of the plurality of panels. The housing may include a circumference between about 85 inches (2.159 meters) and about 95 inches (2.413 meters). The fastener may include a zipper. The zipper may wholly consist of plastic. The animal may be a cat or a dog.

In an aspect, a method disclosed herein may include: moving an actuator of a first cap to a first position, where movement of the actuator to the first position provides a housing defining a substantially rounded shape having a diameter suitable for containing an animal therein, the housing including a plurality of panels at least one of which is gas permeable to allow smells from an external environment to be sensed by the animal from within the housing, and the housing including a plurality of stabilizing rods arranged to maintain the substantially rounded shape of the housing when the actuator is in the first position, each of the plurality of stabilizing rods being substantially flexible to allow for the housing to be at least partially deformed and to return to the substantially rounded shape when in use; engaging a fastener to provide an opening on the housing; placing the animal within the housing through the opening; and engaging the fastener to at least substantially close the opening.

Implementations may include one or more of the following features. The method may further include: engaging the fastener to provide the opening on the housing; removing the animal from the housing through the opening; and moving the actuator from the first position to a second position to reduce the diameter of the substantially rounded shape. When the actuator is in the first position, the housing may be maintained in the substantially rounded shape approximating a sphere, and, when the actuator is in the second position, the diameter of the housing may be reduced such that the housing approximates a cylinder.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 shows a mobile enclosure with an animal in a prone position, in accordance with a representative embodiment.

FIG. 2 shows a mobile enclosure with an animal in a seated and attentive position, in accordance with a representative embodiment.

FIG. 3 shows an animal in an upright position suitable to move a mobile enclosure, in accordance with a representative embodiment.

FIG. 4 shows an animal moving a mobile enclosure, in accordance with a representative embodiment.

FIG. 5 illustrates a mobile enclosure, in accordance with a representative embodiment.

FIG. 6 is a perspective view of a frame for a mobile enclosure, in accordance with a representative embodiment.

FIG. 7 is a top view of a frame for a mobile enclosure, in accordance with a representative embodiment.

FIG. 8 is a side view of a frame for a mobile enclosure, in accordance with a representative embodiment.

FIG. 9 is a perspective view of a frame for a mobile enclosure in a collapsed state, in accordance with a representative embodiment.

FIG. 10 is a side view of a frame for a mobile enclosure in a collapsed state, in accordance with a representative embodiment.

FIG. 11 is an exploded view of a frame for a mobile enclosure, in accordance with a representative embodiment.

FIG. 12 is an actuator for a frame of a mobile enclosure, in accordance with a representative embodiment.

FIG. 13 is a coupler for a frame of a mobile enclosure, in accordance with a representative embodiment.

FIG. 14 is a coupler for a frame of a mobile enclosure, in accordance with a representative embodiment.

FIG. 15 is a stabilizer rod for a frame of a mobile enclosure, in accordance with a representative embodiment.

FIG. 16 is a flow chart of a method for providing a mobile enclosure for an animal, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, kits, and methods disclosed herein generally relate to mobile enclosures for animals such as pets, where such mobile enclosures according to the present teachings can provide a safe way for an animal to exercise and experience other benefits from being outdoors and/or in other environments. It will be understood that although a preferred use-case can include use of a mobile enclosure in an outdoor environment, other environments are also or instead possible including indoor environments. Thus, a skilled artisan will appreciate that, although the present teachings can be advantageous for outdoor use, the present teachings are not limited to such uses. It will be further understood that, although a preferred use-case can include the use of a mobile enclosure for a household pet (e.g., dogs and/or cats; where, in certain aspects, cats can especially benefit from the present teachings), other animals can be used with the present teachings without departing from the scope of this disclosure.

Thus, in general, an aspect of the present teachings may provide safety and enjoyment for an animal to experience an environment that may otherwise present hazards to that animal, such as certain outdoor environments. By way of example, many cat owners do not permit their cats to play and explore outdoors, e.g., for fear of the cats getting lost, climbing tall objects, ingesting undesirous substances, becoming injured or sick, and the like. Thus, a solution for allowing a cat (and/or another animal) to safely play outside may be desirous. To this end, a device according to the present teachings may include a mobile enclosure that is sized and shaped to contain an animal therein, where the mobile enclosure is suitable for the animal to move around an environment relatively easily while situated within the mobile enclosure. That is, an animal pushing on one or more inner surfaces of the mobile enclosure or otherwise applying a predetermined force thereto—e.g., in the same or similar manner to the animal's normal movement such as walking, trotting, galloping, running, and the like—may cause the mobile enclosure to move by rolling or the like. As such, a mobile enclosure according to the present teachings may be rounded, such as by having a substantially spherical shape, and may include a substantially durable frame that permits such movement without collapsing, while still being relatively lightweight as to not be cumbersome for an animal. For example, when contained within a mobile enclosure according to the present teachings, an animal may be able to walk, run, trot, and so on, all while contained within the safety of the mobile enclosure. As such, a mobile enclosure according to the present teachings may include a relatively durable frame that is also flexible to allow for increased mobility over and around objects, and/or for storage. Further, a mobile enclosure according to the present teachings may include one or more panels (e.g., situated between stabilizing rods, such as wires made of spring steel or the like, of a frame of the mobile enclosure) where one or more of these panels can provide breathability and/or visibility, and/or where one or more of these panels can provide shelter from the elements and/or comfort for an animal within the mobile enclosure. Such a device may thus provide safety and security for an animal, e.g., while playing in outdoor environments.

The present teachings may therefore provide several distinct advantages, some of which will now be described by way of example. For example, the present teachings may provide desirous mobility for an animal—by way of example, a cat using a mobile enclosure of the present teachings may be able to walk or run around a backyard and traverse other objects (e.g., over and around debris, roots, small rocks, small elevation changes, and so on), but may be prevented from climbing certain objects such as a fence, a bush, a tree, and so on. That is, the shape and size of aspects of the present teachings may offer extremely easy movement in nearly every direction so that animals can fully explore their surroundings, but in a safe manner—e.g., by otherwise preventing the animal from squeezing through fencing, digging, climbing fences/trees, and so on. The present teachings may also or instead eliminate or greatly diminish the chances of an animal running away or otherwise getting lost, thereby eliminating a fear that many pet owners have when they allow their pets to roam in outdoor environments. The present teachings may also or instead be relatively strong yet lightweight, and/or the present teachings can allow for users to carry an animal (if needed) while situated within a mobile enclosure. By way of example, one or more of the channels as described herein (which may themselves contain a stabilizing rod as described herein) may be used as a handle or other gripping region for picking up a mobile enclosure according to the present teachings (e.g., to pick up an animal and bring them inside when necessary or desired). Aspects of the present teachings may also or instead be collapsible for storage and travel, and as such, certain aspects of the present teachings can be packed for vacations and the like. The present teachings may also or instead protect an animal housed within a mobile enclosure from prey, and/or the present teachings may protect an animal housed within the mobile enclosure from ingesting substances that may be dangerous or unhealthy for the animal such as other animals, plants, bacteria, dirt, animal waste or other waste, water, rocks, other liquids, trash, and the like. The present teachings may also or instead include mobile enclosures that are easily washable—e.g., with a rinse of water from a hose or the like.

While certain enclosures for pets may exist, these existing devices often lack one or more salient aspects of the present teachings that provide specific benefits and advantages of the present teachings, such as those discussed above. For example, existing devices often lack the substantial mobility provided by embodiments of the present teachings, which can be from a lack of a frame and/or panels as described herein. Existing devices may also or instead lack the durability provided by the present teachings, which can be from a lack of the durable yet flexible frame, the panels, the junctions, the channels, and so on, as described herein. Also, while many existing devices are suitable for smaller pets such as rodents and the like, they are not applicable to larger animals such as cats and/or dogs. Existing devices may also or instead lack a balance of providing protection for an animal, while also providing mobility and enjoyment that is afforded by certain aspects of the present teachings. For example, existing devices may lack the panels included on certain aspects of the present teachings, where these panels can be designed to provide cover, shade, and/or other protection from environmental elements, and while these same panels and/or other panels on an aspect of the present teachings may also feature gas permeability for breathability and for the animal to experience sensory interactions with their surrounding environments, such as sights, smells, touch (e.g., from wind or the like), and so on. Thus, it will be understood that such “gasses” may include air from an environment (external or internal environment, e.g., ambient air). That is, embodiments may allow for air flow into and through a mobile enclosure to allow an animal to breathe, but may also allow for other gases to pass through, e.g., so that an animal can experience smells and the like from an environment or contents thereof. Existing devices may also or instead lack certain other safety features and/or accessories that may be included on or with embodiments of the present teachings such as one or more of a handle, a tracking device, a pocket, a photoluminescent material, a tether, a marking, a noise emitter, padding, and so on. Further, existing devices may also or instead lack certain aspects of the frame included on aspects of the present teachings, which as described herein may include a desired balance of rigidity and flexibility, and/or where the present teachings are collapsible for portability and/or storage.

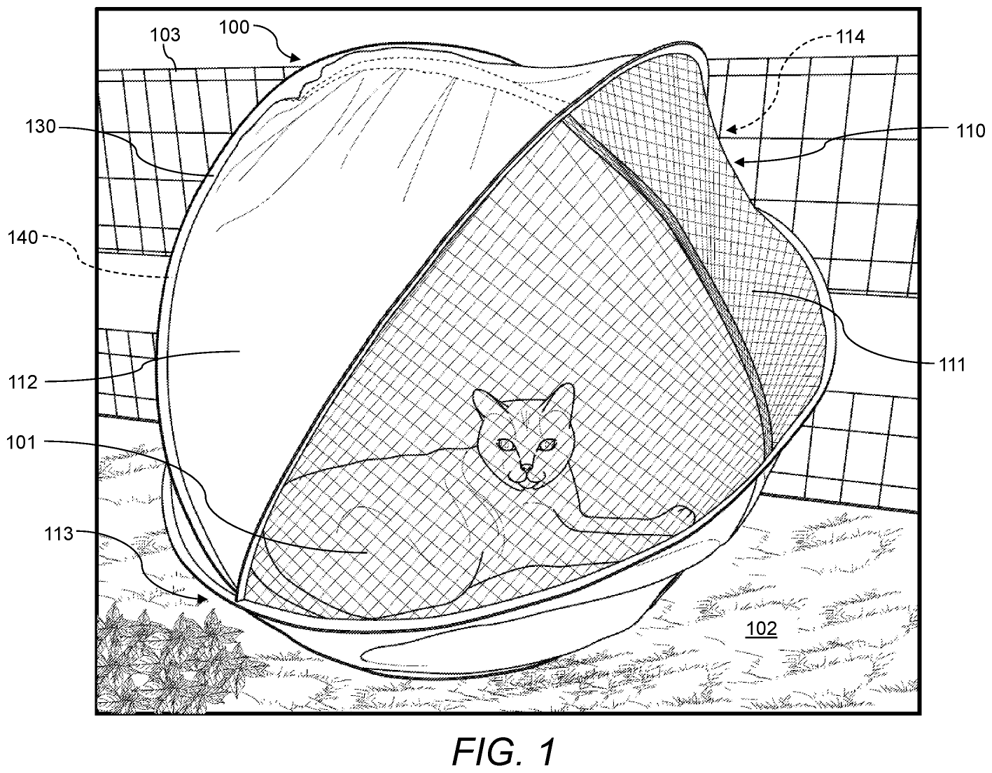

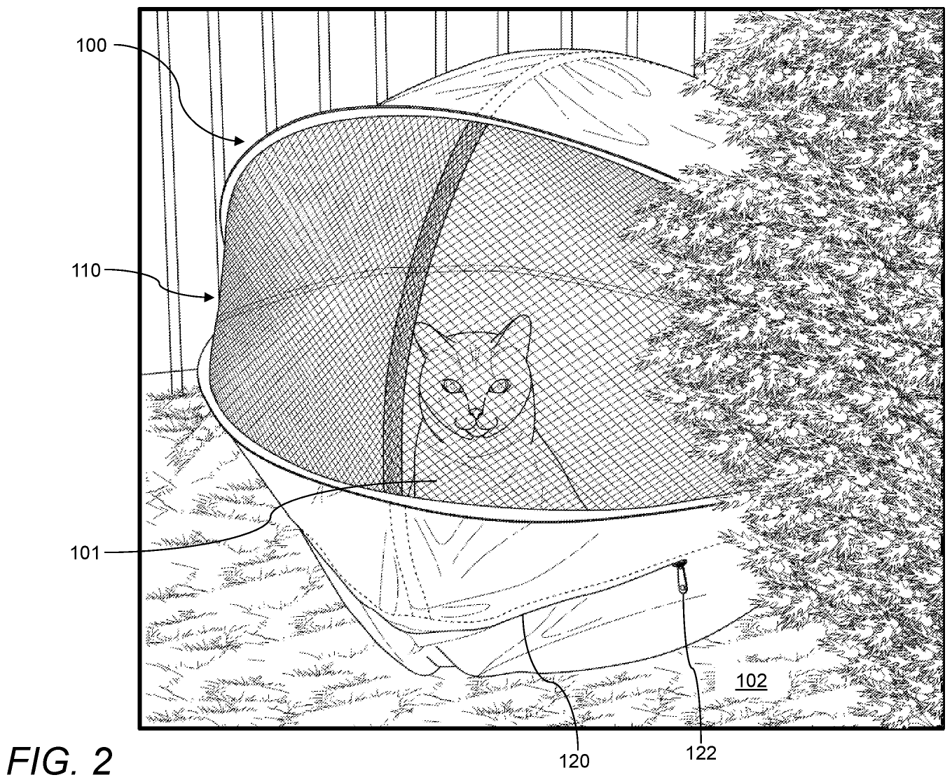

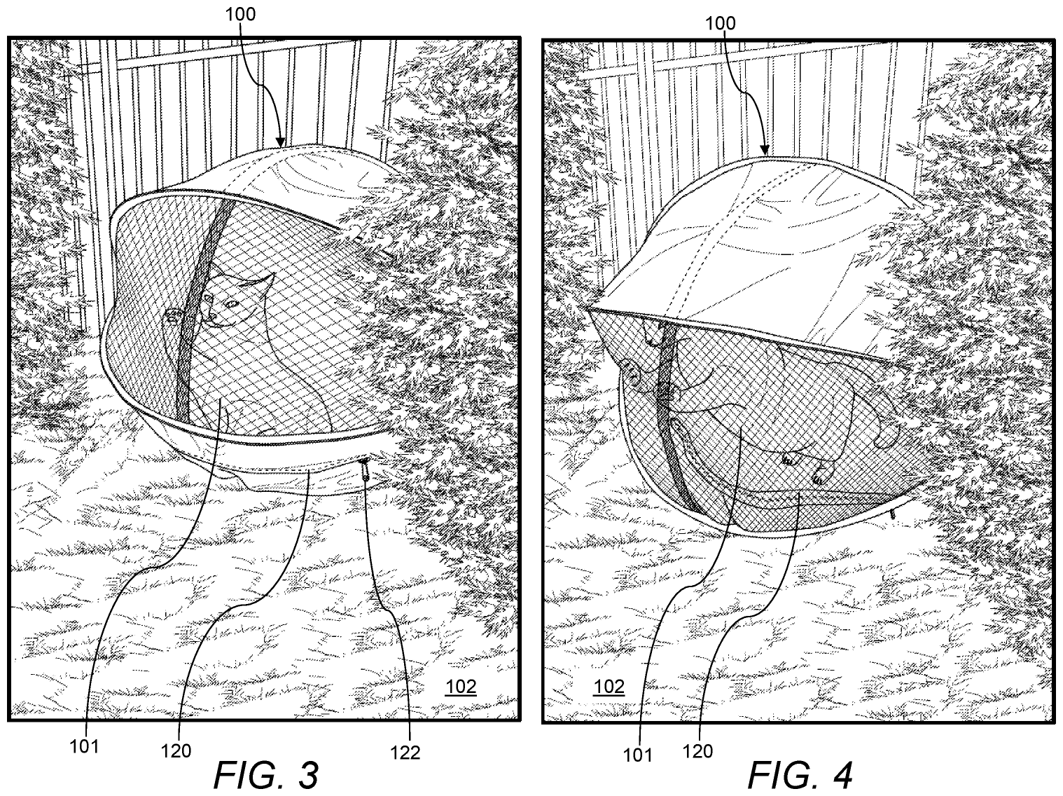

FIGS. 1-4 generally show a device such as a mobile enclosure 100 according to the present teachings. In particular, FIG. 1 shows a mobile enclosure 100 with an animal 101 in a prone position, FIG. 2 shows the mobile enclosure 100 with the animal 101 in a seated and attentive position (e.g., assessing and/or enjoying the external environment 102), FIG. 3 shows the animal 101 in an upright position suitable to move the mobile enclosure 100 (e.g., beginning the process of moving the mobile enclosure 100), and FIG. 4 shows the animal 101 moving the mobile enclosure 100, in accordance with representative embodiments. As described herein, although the animal 101 is shown as a cat in these figures, other animals are also or instead possible for use with the mobile enclosure 100 or similar devices according to the present teachings. And, similarly, although the mobile enclosure 100 is shown in an external environment 102 that includes an outdoor area (e.g., a backyard, a park, and so on), other use environments are also or instead possible with the mobile enclosure 100 or similar devices according to the present teachings, such as indoor environments. In general, the mobile enclosure 100 may include a housing 110 including one or more panels, an opening 120, one or more channels 130, and one or more stabilizing rods 140.

The housing 110 may be structurally configured to contain the animal 101 therein. For example, the housing 110 may be sized and shaped to fit a particular animal and/or a particular set of animals therein. Thus, the size of the housing 110 could be customizable—e.g., via manufacturing different sizes, and/or through post-manufacturing adjustments. Further, the housing 110 may be structurally configured to provide mobility for the animal 101, e.g., where the animal 101 can move throughout the external environment 102 when contained within the mobile enclosure 100, but in a safe manner, such as where the mobile enclosure 100 prevents the animal 101 from traversing a physical boundary such as a fence 103 or the like as shown in the figure. To this end, the housing 110 may include a substantially rounded shape. Stated otherwise, the housing 110 may include a plurality of panels engaged to form a substantially rounded shape having a diameter suitable for containing an animal 101 therein. For example, the housing 110 may be substantially shaped as a sphere or a similar three-dimensional structure (e.g., a ball-like structure) when configured for use. By way of further example, the housing 110 may have a sphere-like shaped defined by a plurality of panels. In certain aspects, the housing 110 may be substantially shaped as an ellipsoid (e.g., a regular or irregularly-shaped ellipsoid, which may include a somewhat flattened sphere). Other shapes are also or instead possible, including substantially polygonal shapes or a mix of rounded and polygonal shapes (e.g., a polygon with substantially rounded edges).

Example dimensions for the housing 110, or more generally for the mobile enclosure 100, will now be provided, but one skilled in the art will understand that other dimensions are also or instead possible. In an aspect, the exterior diameter of the housing 110 (e.g., a maximum exterior diameter of the housing 110, such as where the diameter across different sections may differ) may be about 30 inches (about 76.2 centimeters). In another aspect, the exterior diameter of the housing 110 may be about 45.5 inches (about 115.57 centimeters), the width of the housing 110 (e.g., a minimum exterior diameter of the housing 110, such as where the diameter across different sections may differ) may be about 29.5 inches (about 74.93 centimeters), and an interior diameter of the housing 110 (e.g., a minimum interior diameter of the housing 110) may be about 29 inches (about 73.66 centimeters). Also or instead, the housing 110 may include a circumference between about 85 inches (about 2.159 meters) and about 95 inches (about 2.413 meters); for example, in an aspect, the circumference is about 88 inches (about 2.24 meters). In some implementations, the housing 110 is a near perfect sphere. The weight of the mobile enclosure 100 may be about 2 pounds (about 0.91 kilograms) in an aspect, although other weights are possible.

The housing 110 may include a plurality of panels—e.g., one or more first panels 111 and one or more second panels 112, which may be the same or different from one another. In general, the panels may be engaged to form a substantially rounded shape for the housing 110 overall, and/or the frame of the housing 110 that includes the stabilizing rods 140 may work with the panels (e.g., by providing a structure thereto) to form a substantially rounded shape for the housing 110 overall. In certain implementations, at least one of the plurality of panels is gas permeable, e.g., to allow smells from the external environment 102 to be sensed by the animal 101 from within the housing 110.

As described herein, the housing 110 may be at least partially deformable. That is, one or more components of the housing 110 such as the panels and the frame may be flexible to provide deformation (without collapsing or breaking) of the housing 110 under predetermined forces that the mobile enclosure 100 may undergo in normal use (e.g., from the animal 101 traversing about while disposed within the mobile enclosure 100). Such deformability may be advantageous to allow the animal 101 to move about around an external environment 102, such as moving over debris (e.g., a rock, a stick, a plant, and so on), traversing up and/or down stairs or other elevation changes, and so on. For example, most embodiments of the mobile enclosure 100 may allow an animal 101 to traverse up and down small elevation changes (such as relatively low-profile steps or stairs that are commonly found in yard/patio areas). However, the housing 110 may include a predetermined rigidity such that it does not collapse or break under the predetermined forces that the mobile enclosure 100 may undergo in normal use.

As discussed above, the plurality of panels may include at least one or more first panels 111 and one or more second panels 112. And in certain aspects, one or more of the first panels 111 is different than one or more of the second panels 112—e.g., they may have a different size, shape, material and/or material property, color, accessory, marking, and so on. For example, and as shown in FIGS. 1-4, one or more of the first panels 111 may include a first material that is at least partially transparent or translucent. Also or instead, and as shown in FIGS. 1-4, one or more of the second panels 112 may include a second material that is substantially non-translucent. To this end, in certain implementations, the first material is a mesh material; and, also or instead, in certain implementations, the second material is a canvas material. In certain aspects, the first panels 111 and the second panels 112 alternate along a circumference of the housing 110.

Stated otherwise, one or more of the plurality of panels may include a mesh material. And, in certain aspects, the mesh material is a medium weave breathable mesh material or similar. Also or instead, one or more of the plurality of panels may include a canvas material. And, in certain aspects, the canvas material is an outdoor heavy-duty grade material (e.g., 100% cotton heavy-grade material) or similar. Therefore, an aspect of the present teachings includes a device in the form of a mobile enclosure 100 that has panels or other regions that include a mesh material for visibility, shade, and/or breathability, but that also has panels or other regions structurally configured to provide more robust protection from the elements, such as a canvas material that can provide shade and that is substantially waterproof or water resistant. Thus, certain aspects of the present teachings may include panels or other regions including a relatively strong breathable mesh material that allows for substantially constant air movement throughout the mobile enclosure 100. The mesh portions (or the like) may also or instead provide full, or nearly full, visibility so that the animal 101 can enjoy the external environment 102 in a manner that is less disruptive to its sensory experiences. And the canvas portions (or the like) may be used, for example, to offer a safe ground cover for the animal 101 to lay on, to act as a sun shade, to provide protection from rain or other elements of the external environment 102, and so on. One or more of these panels may also or instead be padded for comfort of the animal 101.

In an implementation, the housing 110 includes only a single panel—e.g., a continuous piece of material (or multiple materials connected to form a single panel) that is draped over a frame to form the housing 110, or that otherwise includes channels or the like that receives the frame to form the housing 110. That is, in an aspect, panels of the housing 110 may simply be formed by a sheet of material(s) used to form the housing 110.

The panels or other structures and components that make up the housing 110 may also or instead include other advantageous features. For example, in certain aspects, each of the plurality of panels are made of a fabric material, where the fabric material (e.g., a fabric pattern of the fabric material) is structurally configured to prevent claws of the animal 101 from snagging along the fabric material. To this end, where a mesh material or similar is used, the size of the mesh grid pattern may be selected so that nails and/or claws and/or other attributes of an animal 101 will not get caught in-between the sections that form the mesh grid pattern. By way of further example, the housing 110 may be structurally configured to prevent or hinder access by pests and/or predators to the animal 101 when contained within the mobile enclosure 100. To this end, the housing 110 may be structurally configured to prevent or hinder insects, bugs, and the like such as mosquitoes, flies, fleas, ticks, spiders, and the like from getting to the animal 101 when the animal is contained within the housing 110. Also or instead, the housing 110 may be structurally configured to prevent or hinder predators from access to an animal 101 contained therein—e.g., the housing 110 can prevent or mitigate injuries from birds (e.g., hawks, owls, eagles, and the like), cayotes, dogs, cats, rats, and the like. Moreover, the housing 110 may be structurally configured to help an animal 101 stay relatively clean when in an external environment 102, e.g., by using fabrics to protect the animal 101.

The opening 120, which is best shown in FIGS. 2-4, may be disposed on the housing 110, and may be sized and shaped to receive the animal 101 therethrough. That is, the size and shape of the opening 120 (when open) may be structurally configured to be long enough such that most domesticated animals can hop in and out with relative ease (e.g., cats and dogs). For example, in certain aspects, the opening 120 spans almost the full length of one panel. The opening 120 may also or instead be reinforced on the housing 110 to prevent fraying, tearing, and the like. For example, the material (e.g., fabric) that abuts the opening 120 may be bonded to prevent fraying and the like.

The opening 120 may be selectively closable and openable via a fastener 122. In some implementations, and as shown in the figure, the fastener 122 may include a zipper or the like. Further, in some implementations, the fastener 122 (such as the zipper shown in the figures) may wholly consist of plastic or another similar material that is one or more of rustproof, corrosive resistant, safe for animals, and the like. Thus, in certain aspects, the fastener 122 includes a heavy-duty plastic zipper or the like, which may be the same or similar to those typically found on sailboats and the like—i.e., a relatively strong zipper that will not rust and that is not prone to snagging or otherwise getting hung up on the material surrounding the zipper. Other types of fasteners 122 are also or instead possible for the opening 120 including without limitation one or more of a clamp, a clip, a hook and loop fastening system, a latch, a lock, a pin, a screw, a snap, a button, magnets, an adhesive, and the like.

Example dimensions for the opening 120 will now be described although it will be understood that other dimensions (and/or sizes and/or shapes) for the opening 120 are also or instead possible. The length of the opening 120 may be about 27 inches (about 68.58 centimeters), and when configured as a zipper with a zipper pull, the zipper pull may be about 1.5 inches (about 3.81 centimeters) long, which can allow for a relatively easy grip by a user to open and/or close the opening 120.

As discussed herein, the mobile enclosure 100 may include a plurality of channels 130, and/or other features that allow fabric panels or the like to engage with one or more stabilizing rods 140. The plurality of channels 130 may be disposed along the housing 110, e.g., from a first end 113 of the housing 110 to a second end 114 of the housing 110, where these “ends” of the housing 110 may generally be configured as the poles of the rounded shape defined by the housing 110 when the mobile enclosure 100 is configured for use. In general, a channel 130 may define a pocket, a void, a sleeve, a fixture, a loop, or the like that is structurally configured to receive or otherwise engage a stabilizing rod 140 therein or thereon, e.g., in a manner that forms a frame for the mobile enclosure 100. It will therefore be understood that, also or instead of a channel 130, the mobile enclosure 100 may include fasteners, voids, protrusions, and/or other mechanical features that engage with one or more stabilizing rods 140 to form at least part of a frame for the housing 110.

As discussed herein, a stabilizing rod 140 may be disposed within, or otherwise engaged with, each of the plurality of channels 130 or another portion of the panels. Each stabilizing rod 140 may be substantially flexible to allow for the stabilizing rod 140, and thus the housing 110, to be at least partially deformed without breaking during intended uses, and to be biased in some configurations to return to an intended shape after such deformations. That is, the stabilizing rods 140 may be substantially flexible to allow for the housing 110 to be at least partially deformed and to return to the substantially rounded shape during use. For example, the stabilizing rods 140 and the panels that collectively form a shape of the housing 110—which again may approximate a sphere, ellipsoid, or similar—may be structurally configured to substantially maintain this shape when in use—e.g., the stabilizing rods 140 may be biased to form the intended shape of the housing 110. In this manner, when an animal 101 uses the mobile enclosure 100 and, for example, traverses over an obstruction (such as a rock, plant life such as a root or branch, a curb or other manmade object, a slight change in elevation, and so on), the housing 110 may be able to slightly deform (which can mitigate failure/breaking and can assist in comfort for the animal 101 when maneuvering the mobile enclosure 100 about an environment, and particularly an outdoor environment) and then flex back to return to its original, at-rest shape. This “slight” deformation may include a deformation from an original shape of about 5%, 10%, 20%, 30%, 40%, or more (it will be understood that deformations may vary), where the stabilizing rods 140 flex accordingly to provide the deformation, and where the stabilizing rods 140 are biased to return to the at-rest shape of the mobile enclosure 100 when forces that caused the slight deformation are removed.

By way of example, one or more of the stabilizing rods 140 (e.g., each stabilizing rod 140) may include a wire made at least partially using a spring steel or the like, or another type of wire. Specifically, one or more of the stabilizing rods 14 may include a spring metal of grade 0.094 that provides a relatively lightweight, stable housing 110, where portions of the housing 110 will not crimp. In this manner, the channels 130 and the stabilizing rods 140 may define a frame for the mobile enclosure 100—e.g., a metal frame for stability, but that also provides some flexibility. And, because of the materials selected for use in the mobile enclosure 100 such as those described herein, the mobile enclosure 100 may be relatively lightweight while also allowing the animal 101 to walk, roam, and ‘run’ inside the device, and in turn, to move across the surfaces of an external environment 102 (e.g., to aid in their hunting nature, while providing a relatively safe and comfortable place for them to rest and/or sleep).

One or more of the ends of the mobile enclosure 100 may include a junction that aids in the stability and/or flexibility of the housing 110, and examples of these junctions are provided in more detail below. The stabilizing rods 140 (or other features of the mobile enclosure 100) may be specifically structurally configured to cooperate with these junctions or otherwise with an end of the mobile enclosure 100. By way of example, and as described in more detail below, a stabilizing rod 140 may include one or more hooked ends that are structurally configured to engage with a feature of an end of the mobile enclosure 100.

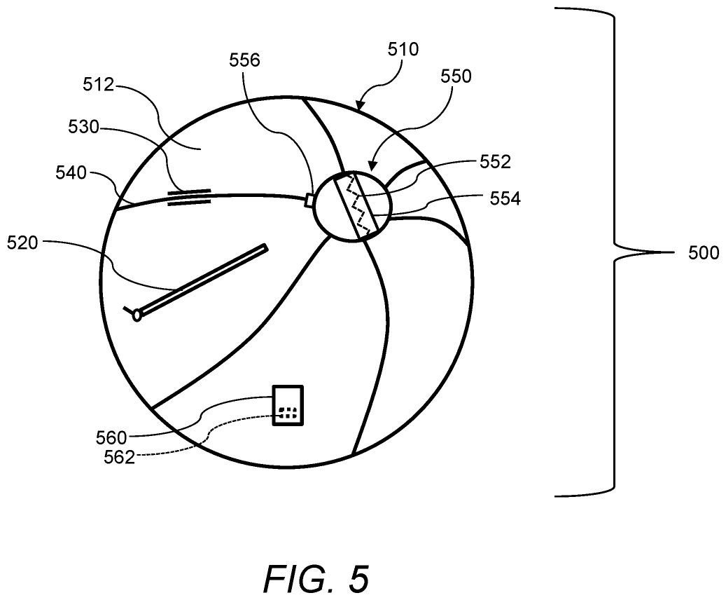

FIG. 5 illustrates a mobile enclosure 500, in accordance with a representative embodiment. It will be understood that the mobile enclosure 500 of FIG. 5 may be the same as or similar to the mobile enclosures 100 described above with reference to FIGS. 1-4, and thus the mobile enclosure 500 of FIG. 5 may include any one or more of the features described above, and vice-versa. And, in general, the mobile enclosure 500 may include a housing 510 including one or more panels 512, an opening 520, one or more channels 530, and one or more stabilizing rods 540. Further, as referred to above, one or more of the ends of the mobile enclosure 500 may include a junction 550 that aids in the stability and/or flexibility of the housing 510.

The junction 550 may include an end cap or the like that is structurally configured to secure ends of one or more of the stabilizing rods 540 in an intended position, e.g., in engagement with another portion of the frame of the housing 510 such as another one or more stabilizing rods 540 (which, in some aspects, may include the same stabilizing rod 540, e.g., by joining one end of a stabilizing rod 540 to another end of the same stabilizing rod 540). Stated otherwise, one or more of the first end of the housing 510 and the second end of the housing 510 may include a junction 550 whereby an end of a stabilizing rod 540 is secured—e.g., where ends of each stabilizing rod 540 are engaged with one another or to another structure. By way of example, and as shown in representative form in the figure, the junction 550 may include at least six ends of the stabilizing rods 540. In other aspects, the junction 550 may include at least three ends of the stabilizing rods 540. In certain aspects, the junction 550 or end cap may include a diameter of about 1.5 inches (about 3.81 centimeters).

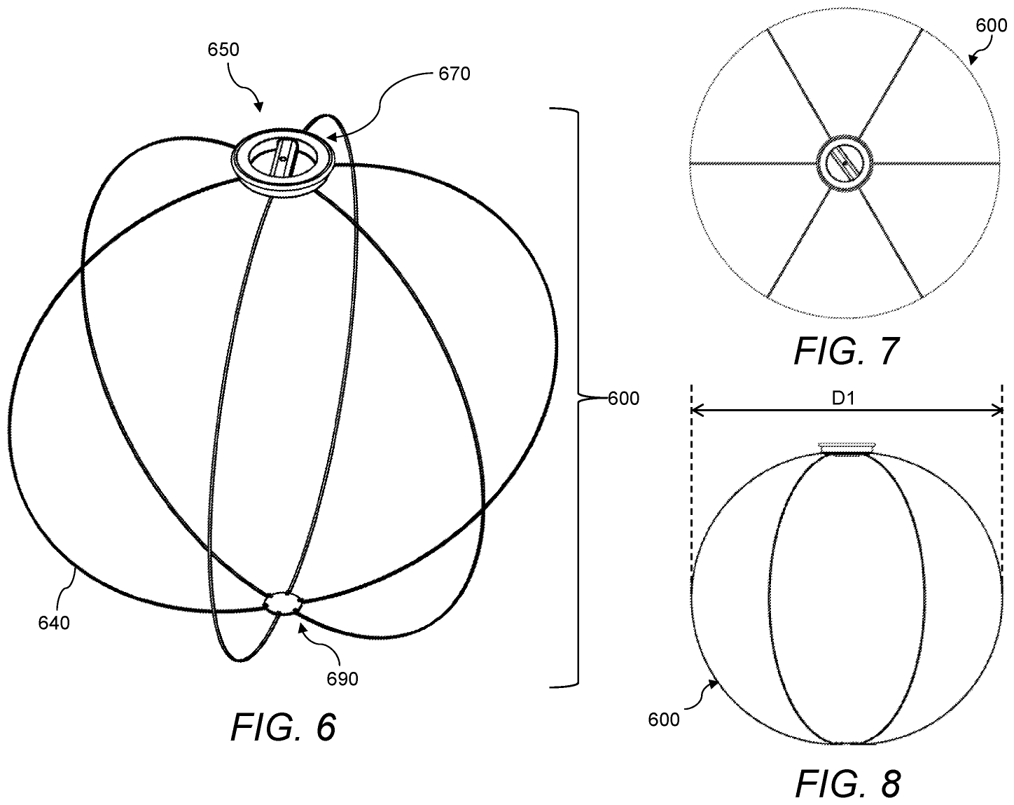

It will be understood that there are a plurality of ways that such a junction 550 can be formed on one or more ends of the mobile enclosure 500. Two examples include the use of spring clips 552 or the like (discussed below) and/or using a cap/actuator mechanism or the like (such as that described with reference to FIGS. 6-15 described herein).

As shown in FIG. 5, the junction 550 may include one or more spring clips 552 or the like that secure one or more stabilizing rods 540—e.g., where these spring clips 552 or the like connect an end of a stabilizing rod 540 to another end of another stabilizing rod 540 (or to another end of the same stabilizing rod 540). Such a spring clip 552 may provide flexure for the housing 510 and/or a capability to at least partially deform the housing 510, e.g., when in use (a slight deformation) and/or for storage (a substantial deformation). A spring clip 552 used herein may be the same or similar to a 1050-1095 spring steel slotted spring pin, such as those that are about 5/32-inches in diameter and 1-inch long available from McMaster-Carr Supply Company. One or more of such spring clips 552 (e.g., each of the spring clips 552) may be reinforced for stability. To this end, reinforcement of a spring clip 552 may include placement of a tape 554 or the like about the spring clip 552, although other reinforcement is also or instead possible, including without limitation placement of another material, a cap, or the like over the spring clip 552. By way of example, a tape 554 used for reinforcement may include a shrink tape that is melted about a spring clip 552 after placement about the spring clip 552. Also or instead, material may be placed about a spring clip 552 for reinforcement thereof (e.g., a canvas material or the like may be used to reinforce a spring clip 552 or other junction of stabilizing rods 540). In an implementation of the present teachings, the junction 550 includes at least six ends of the stabilizing rods 540 and at least three spring clips 552, where each of the spring clips 552 connects at least two of the ends of the stabilizing rods 540. Other configurations are also or instead possible as will be understood by a skilled artisan.

Thus, in certain aspects, one or more end caps of the mobile enclosure 500 may be structurally configured to stabilize a frame for a housing 510 thereof. By way of example, one end of the mobile enclosure 500 may have a channel-over-channel design using three or more layers of material to hold it together (e.g., layers of mesh and canvas materials, or similar). The other end of the mobile enclosure 500 may be where ends of the stabilizing rods 540 (e.g., six total ends) feed into spring clips 552 (e.g., three spring clips 552) for safety, structure, stability and/or to help give the mobile enclosure 500 its substantially rounded shape, e.g., substantially spherical or ellipsoid. A securing component such as tape 554 (e.g., shrink tape) or material may be engaged thereto—e.g., in the example using shrink tape, the shrink tape may be placed on an end of a stabilizing rod 540 and melted around a spring clip 552 (e.g., placed on all spring clips 552), which can ensure that the stabilizing rod 540 will not break free from the spring clip 552. In this manner, such a junction 550 may allow for secure movement of the mobile enclosure 500 about an environment, movement and/or stability of the animal inside the mobile enclosure 500, carrying of the mobile enclosure 500, and the like, by adding more stability (e.g., by preventing the stabilizing rods 540 from releasing from the spring clips 552).

Also, or instead, an end cap of the mobile enclosure 500 may include one or more couplers 556 that secure one or more ends of the stabilizing rods 540. For example, the end cap may include a substantially rigid structure such as a ring or the like, where ends of the stabilizing rods 540 are engaged thereto via a coupler 556. Such a coupler 556 may include any as known in the art, and/or such a coupler 556 may be configured to move about the end cap, e.g., via a bearing or the like. And, such a coupling using a coupler 556 may be permanent or releasable (e.g., for releasing and/or collapsing the structure of the mobile enclosure 500 for storage of the mobile enclosure 500).

The mobile enclosure 500 may further include one or more auxiliary components 560. By way of example, such an auxiliary component 560 may include a handle disposed on the housing 510. Such a handle may be an independent component (e.g., a handle sewn onto, adhered to, or otherwise coupled to the housing 510) and/or a handle may be formed by another part of the mobile enclosure 500. For example, in certain aspects, the handle is formed by one or more of the stabilizing rods 540. That is, in an aspect, one or more of the channels 530 with a stabilizing rod 540 therein can be used as a ‘handle’ to pick up the mobile enclosure 500 (with or without the animal contained therein) for transport or otherwise. It will be understood that the mobile enclosure 500 may include a plurality of handles, such as handles that are disposed on opposing sides of the mobile enclosure 500.

The auxiliary component 560 may also or instead include a pocket or other holder for receiving an accessory 562 therein or thereon. Such a pocket and/or holder may be waterproof or water resistant. By way of example, such an accessory 562 may include a tracking device, which may be removable and replaceable within a pocket or the like. Stated otherwise, the mobile enclosure 500 may include a tracking device on the housing 510. Thus, in an implementation, the mobile enclosure 500 may include a relatively small pocket with an enclosure (e.g., a hook and loop enclosure) that can hold a tracking device (e.g., a GPS tracking device or similar, which can have long or short-range communications capability). In this manner, a user can utilize a computing device (e.g., a smartphone) that communicates with the tracking device for locating the mobile enclosure 500, e.g., in the event that an animal leaves a predetermined area. And, in this manner, a system including a mobile enclosure 500 may include one or more network-connected devices for communication and/or data transfer over a data network such as the internet. For example, such a system may utilize C# (C Sharp) and cloud based services that are used to develop a mobile application, where metadata and the like may be received and/or stored for use (e.g., metadata corresponding to one or more of the mobile enclosure 500, a geographical location, contents of the mobile enclosure 500 such as animal name or type, other tracking information, owner information, status information, health information, and the like). This information and data may be stored in cloud-based services and databases to facilitate sharing and availability, where it can be deployed to mobile devices having various operating systems (e.g., Android and/or iOS) as well as desktop computing devices and the like.

The auxiliary component 560 may also or instead include a photoluminescent material on the housing 110, which may in some instances include a florescent tape or fabric. Also or instead, one or more of the plurality of panels 512 may be made at least partially from a photoluminescent material. In this manner, such a material may illuminate the mobile enclosure 500 in dark conditions (e.g., at night) to assist a user in finding the mobile enclosure 500 and/or an animal therein. The auxiliary component 560 may also or instead include a light or other display device, e.g., to illuminate the mobile enclosure 500 in dark conditions.

The auxiliary component 560 may also or instead include a tether (and/or a connection for a tether), which may be selectively attachable to the housing 510. In this manner, an auxiliary component 560 such as a tether or the like may be provided in a kit that includes the mobile enclosure 500 for engagement thereto. That is, in certain aspects, a tether may be provided that can connect to the mobile enclosure 500, e.g., for securing an end to a fixed structure to limit movement of the mobile enclosure 500 to predefined areas. The tether may also or instead include a leash or the like, e.g., for walking an animal while situated within the mobile enclosure 500.

The auxiliary component 560 may also or instead include one or more markings. The markings may include identifying information for the animal, which may include contact information for a user associated with the animal. By way of example, certain aspects include a waterproof clear plastic sleeve (or the like) and/or tag that has information such as the animal's name, address, and owner's phone number in case the mobile enclosure 500 is temporarily lost.

The auxiliary component 560 may also or instead include a noise emitter, which may include a bell or the like. That is, in certain aspects, the mobile enclosure 500 may include a small bell and/or another sounding device—in this manner, when the animal moves, a user will be able to hear the noise emitter.

The auxiliary component 560 may also or instead include padding disposed along one or more of the plurality of panels 512. By way of example, each solid section (e.g., non-transparent section, such as those made of canvas) of the device may be lightly padded to provide comfort for an animal to sit, lay, and/or sleep on.

It will be understood that the mobile enclosures described herein may be customizable to an animal, owner, association, and the like. By way of example, the mobile enclosure 500 may include different colored canvas fabrics for girl/boy/gender neutral animal options.

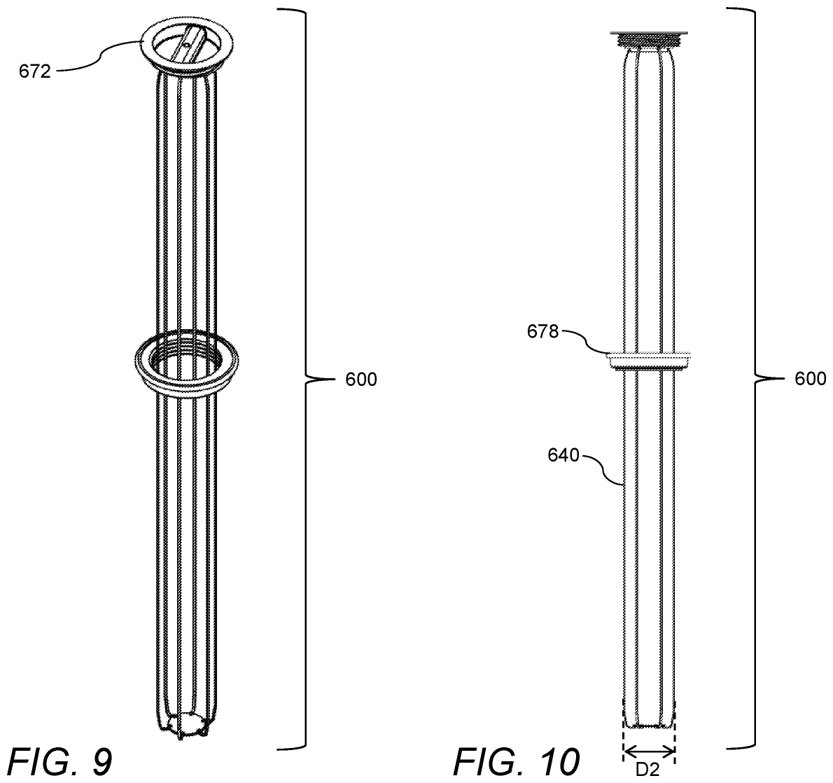

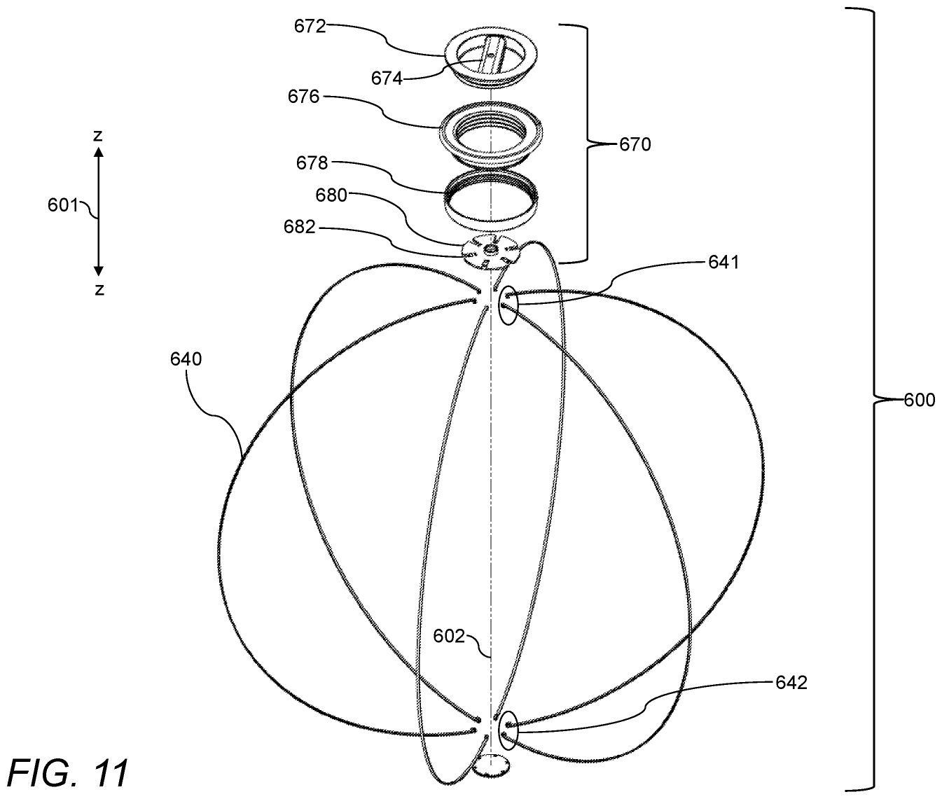

FIG. 6 is a perspective view of a frame for a mobile enclosure, in accordance with a representative embodiment; FIG. 7 is a top view of a frame for a mobile enclosure, in accordance with a representative embodiment; and FIG. 8 is a side view of a frame for a mobile enclosure, in accordance with a representative embodiment. The frame shown in FIGS. 6-8 may be collapsible. In this manner, FIG. 9 is a perspective view of a frame for a mobile enclosure in a collapsed state, in accordance with a representative embodiment; and FIG. 10 is a side view of a frame for a mobile enclosure in a collapsed state, in accordance with a representative embodiment. And FIG. 11 is an exploded view of a frame for a mobile enclosure, in accordance with a representative embodiment.

As shown in FIGS. 6-8, when the frame 600 is in an expanded state, the frame 600 (and thus a housing of a mobile enclosure including the frame 600) may include a substantially rounded shape, such as a shape approximating a sphere or an ellipsoid. The expanded state of the frame 600 may represent a state configured for use, e.g., by placing an animal within the perimeter of the frame 600, i.e., inside the frame 600. As shown in FIGS. 9 and 10, when the frame 600 is in a collapsed state, the frame 600 (and thus a housing of a mobile enclosure including the frame 600) may include a reduced diameter and may, for example, include a shape that approximates a cylinder or the like.

The frame 600 shown in FIGS. 6-11 may be the same or similar to any of the frames described herein, e.g., with reference to FIGS. 1-5. Thus, it will be understood that any one or more of the features of the embodiments shown and described with reference to FIGS. 1-5 may be included on an embodiment of a mobile enclosure including the frame 600 shown in FIGS. 6-11. It will be further understood that any one or more of the features of the frame 600 shown in FIGS. 6-11 may also or instead be included in the embodiments shown and described with reference to FIGS. 1-5. In general, the frame 600 shown in FIGS. 6-11 may be used for a mobile enclosure configured to contain an animal therein, e.g., for a pet to safely explore outdoor environments. The frame 600 may generally include one or more stabilizing rods 640 and a junction 650 formed on one or more ends of the frame 600, e.g., for securing the stabilizing rods 640 in an intended shape. And, more particularly, one or more of the junctions 650 may facilitate transitions of the frame 600 between its expanded state (e.g., for use and enjoyment by an animal) and its collapsed state (e.g., for transport and/or storage of a mobile enclosure).

In certain aspects, a junction 650 includes a first cap 670 structurally configured to couple with ends of each stabilizing rod 640 via one or more connection points that selectively permit movement of the ends of each stabilizing rod 640 (e.g., relative to the first cap 670 and/or along a central axis), where the movement facilitates deformation of the housing that reduces the diameter of the substantially rounded shape thereof. For example, the diameter may be reduced from a first diameter D1 shown in FIG. 8 to a second diameter D2 shown in FIG. 10. In some aspects, D1 is about six times greater than D2, although other relative dimensions are possible. A junction 650 may instead include a second cap 690 structurally configured to couple with ends of each stabilizing rod 640. In some aspects, the second cap 690 is disposed at an opposite end of the frame 600 or housing from the first cap 670.

As best shown in FIG. 11, the first cap 670 may include an actuator 672 (shown as a knob in the figure, although other embodiments are also or instead possible, such as a push button or the like), an engagement portion 676 (shown as a threaded ring in the figure, although other embodiments are also or instead possible), a stabilizing ring 678 (shown as a snap ring in the figure, although other embodiments are also or instead possible), and a first annular coupler 680 (shown as a floating ring in the figure, although other embodiments are also or instead possible). In general, the actuator 672 may be movable (e.g., through its cooperation with the engagement portion 676, such as a threaded engagement) relative to the frame 600, where such movement also causes movement of the first annular coupler 680, which itself may be engaged with ends of stabilizing rods 640, and where such movement facilitates transitions between the expanded and collapsed states of the frame 600, e.g., through movement of the ends of stabilizing rods 640 relative to the frame 600 caused by the actuator 672 being activated by a user.

As stated above, in general, the first cap 670 may be structurally configured to couple with ends of each stabilizing rod 640 (e.g., one or more of a first end 641 and a second end 642) thereof. In particular, this coupling may be provided through one or more connection points 682 that selectively permit movement of ends of the stabilizing rods 640, where the movement facilitates a deformation of the frame 600 (or housing of a mobile enclosure as described herein) that either reduces the diameter of a substantially rounded shape thereof or that increases the diameter to form the substantially rounded shape thereof. The connection points 682 may be facilitated by, and/or formed on, the first annular coupler 680. Movement of ends of the stabilizing rods 640 relative to the first cap 670 may include rotational movement. In this manner, one or more of the connection points 682 may include one or more hinges, and/or a structural arrangement that facilitates rotational movement.

The actuator 672 may be movable between a first position and a second position. In an aspect, when the actuator 672 is in the first position, the frame 600 or housing is maintained in a substantially rounded shape (e.g., approximating a sphere), and when the actuator 672 is in the second position, the diameter of the frame 600 or housing is reduced (e.g., such that the frame 600 or housing approximates a cylinder). And, in some aspects, when the actuator 672 is in the second position, the first cap 670 at least partially defines a void configured to receive at least a portion of material, e.g., material defining one or more panels of the mobile enclosure including the frame 600. That is, the actuator 672 in the first position may include the actuator 672 in a position along a z-axis 601 (or, more particularly, along a central axis 602 of the frame 600 or housing) that is closer in proximity to the stabilizing ring 678 (or, more generally, closer to the second cap 690) than when the actuator 672 is in the second position. Thus, movement of the actuator 672 from the first position to the second position along the z-axis 601 or central axis 602 may provide a gap or void within the structure of the first cap 670. And, the gap or void that is formed may be structurally configured to receive at least a portion of material that makes a panel (and/or another portion) of a mobile enclosure including the frame 600. In this manner, loose material caused by collapsing the frame 600 may be stored within the void.

Movement of the actuator 672 may include one or more of (i) a rotation about a central axis 602 of the frame 600 or housing, and (ii) movement along the central axis 602 of the frame 600 or housing. For example, the actuator 672 may be structurally configured to rotationally engage with the engagement portion 676, e.g., where cooperating threading on these components facilitates the engagement and relative movement therebetween. To this end, the actuator 672 may include a gripping portion 674 (e.g., a handle, a knob, or the like) where a user can grasp the actuator 672 for activation thereof—e.g., rotational movement that also provides movement along the central axis 602. The actuator 672 may also or instead be moved between its first and second position through the application of other forces in addition to or instead of rotation relative to the engagement portion 676. For example, in an aspect, the actuator 672 may be pushed down (or up) to move the actuator 672 between its first and second position and/or to release the actuator 672 from a locked state where it is prevented from movement between its first and second positions. To this end, the gripping portion 674 may also or instead include a button or the like. The actuator 672 may be purely mechanical, or the actuator 672 may include an electrical component to facilitate movement thereof.

Regardless of how movement of the actuator 672 is achieved, in certain implementations, movement of the actuator 672 causes movement of a first annular coupler 680 (where the first annular coupler 680 includes one or more connection points 682 for engaging ends of the stabilizing rods 640) along the central axis 602 of the frame 600 or housing. And, in some aspects, movement of the first annular coupler 680 facilitates movement of the ends of the stabilizing rods 640 along the central axis 602 of the frame 600 or housing. This may, in turn, provide for one or more of collapsing or expanding the frame 600 or housing of a mobile enclosure according to the present teachings.

Turning back to FIGS. 9 and 10, which again show the frame 600 in a collapsed state (e.g., for transportation and/or storage), these figures thus show the actuator 672 in the second position where D2 is less than D1, and where the frame 600 or housing may approximate a cylinder or tube instead of a sphere or the like. In certain implementations, one or more of the components of the first cap 670 may be configured to maintain the frame 600 in the collapsed state. This can be accomplished, for example, through the threaded engagement (or other engagement) of the actuator 670 with the engagement portion 676 or the like. Also or instead, this can be accomplished through movement of another portion of the first cap 670, such as by sliding a component (e.g., the stabilizing ring 678) along the stabilizing rods 640 (e.g., away from the actuator 670) to retain a position of the stabilizing rods 640 in a substantially linear state or otherwise a state that provides a reduced diameter D2 of the frame 600. In this manner, a substantially cylindrical shape of the frame 600 may be maintained.

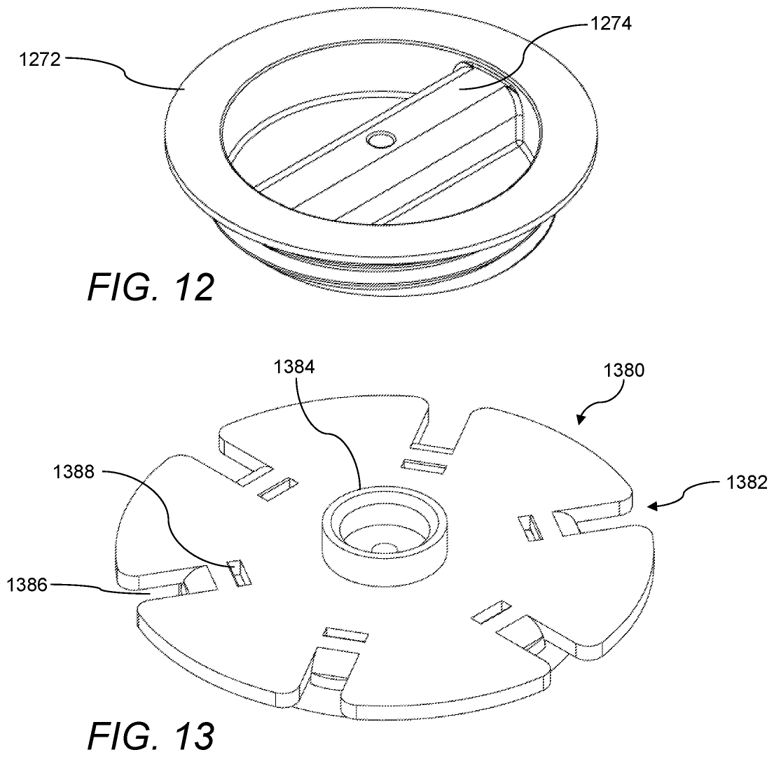

FIG. 12 is an actuator for a frame of a mobile enclosure, in accordance with a representative embodiment. The actuator 1272 may be the same or similar to that described above with reference to FIGS. 6-11. Thus, the actuator 1272 may be part of a first cap for a mobile enclosure and/or a frame thereof. The actuator 1272 may include a region structurally configured for user engagement—e.g., the actuator 1272 may include a gripping portion 1274. The gripping portion 1274 may feature a handle, a button, or the like. More generally, the gripping portion 1274 may include one or more indentations and/or protrusions that are structurally configured to promote and/or facilitate user engagement. The actuator 1272 may also or instead include a locking component structurally configured to maintain a position thereof relative to a frame of a mobile enclosure as described herein.

The actuator 1272 may be movable within a first cap as described herein, where movement of the actuator 1272 may cause movement of one or more other components (of the first cap or otherwise) to cause expanding and/or collapsing of a mobile enclosure and/or a frame thereof. To this end, the actuator 1272 may include one or more projections and/or one or more protrusions that cooperate with another component to translate movement thereto. By way of example, the actuator 1272 may include a protrusion on a bottom surface thereof that engages with a portion of another component (e.g., a top surface thereof) to move that other component in a predetermined manner—e.g., a coupler as described below.

FIG. 13 is a coupler for a frame of a mobile enclosure, in accordance with a representative embodiment. In particular, the coupler shown in this figure may include an annular coupler 1380, which may be the same or similar to any as described herein such as the first annular coupler 680 shown and described above. Thus, the annular coupler 1380 may be part of a first cap for a mobile enclosure and/or a frame thereof. Moreover, in some aspects, the annular coupler 1380 is movable within the first cap (and/or relative to a frame of a mobile enclosure) where movement of the annular coupler 1380 affects elements that are coupled therewith, such as one or more stabilizing rods as described herein. Also, or instead, the annular coupler 1380 may be substantially stationary within the first cap (and/or relative to a frame of a mobile enclosure), where another component engages with the annular coupler 1380 to affect elements that are coupled therewith, such as one or more stabilizing rods as described herein. For example, movement of an actuator may provide for movement of one or more of the annular coupler 1380 and/or stabilizing rods engaged therewith. That is, in an aspect, movement of the actuator subsequently moves (through direct or indirect contact) one or more of the annular coupler 1380 itself and stabilizing rods engaged therewith. To this end, the annular coupler 1380 may include one or more features to engage with (directly or indirectly) an actuator, such as a projection 1384 on a top surface thereof as shown in the figure (and/or a protrusion). Other configurations are also or instead possible.

The annular coupler 1380 may also or instead include one or more connection points 1382 that are structurally configured to engage with ends of a stabilizing rod, e.g., hooked ends thereof. Also, or instead, the connection points 1382 may be structurally configured to selectively permit movement of an end of a stabilizing rod relative to the annular coupler 1380. This movement may facilitate a deformation of a mobile enclosure or a frame thereof, e.g., where movement either reduces the diameter of a substantially rounded shape thereof or increases the diameter to form the substantially rounded shape thereof. Movement of ends of the stabilizing rods relative to the annular coupler 1380 may include rotational movement. In this manner, one or more of the connection points 1382 may include one or more hinges, and/or a structural arrangement that facilitates rotational or substantially hinged movement.

By way of example, connection points 1382 of the annular coupler 1380 may include one or more of an indentation 1386 and a slot 1388. The indentation 1386 may be structurally configured to engage with a portion of an end of a stabilizing rod, such as a portion substantially adjacent to a hooked end thereof. And the slot 1388 may be structurally configured to engage with the hooked end of a stabilizing rod. For example, a substantially terminal end of the stabilizing rod may be disposed through the slot 1388, where, when so situated, the indentation 1386 allows selective rotational movement of the end of the stabilizing rod. This rotational movement may allow the end of the stabilizing rod to move axially along a central axis of a mobile enclosure, thereby expanding and contracting the stabilizing rod, which in turn may affect the shape of the mobile enclosure as described herein. Other configurations are possible as will be understood by skilled artisans.

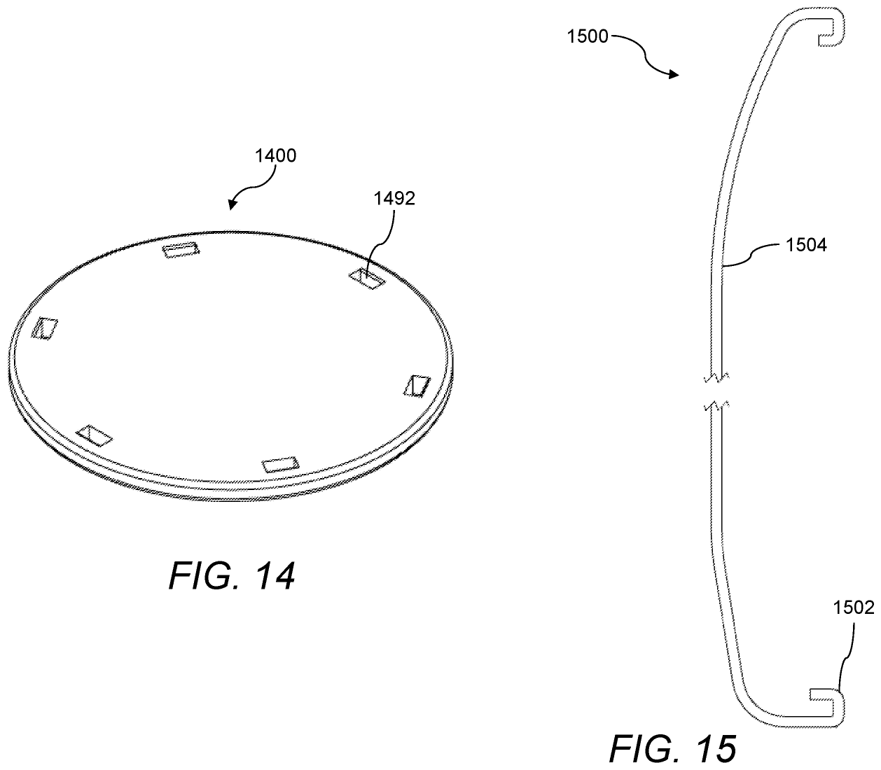

FIG. 14 is a coupler for a frame of a mobile enclosure, in accordance with a representative embodiment. The coupler shown in this figure may include at least a portion of a second cap as described herein. That is, the coupler may include a second annular coupler 1400 that engages with one or more stabilizing rods as described herein. To this end, the second annular coupler 1400 may include one or more connection points in the form of slots 1492 or the like. The connection points of the second annular coupler 1400 may instead include a similar arrangement to the connection points 1382 described above. Turning back to FIG. 14, the connection points of the second annular coupler 1400 (e.g., the slots 1492 of the second annular coupler 1400) may be structurally configured to permit less movement of ends of the stabilizing rods relative to the selective movement permitted by the connection points 1382 described above. In this manner, the second annular coupler 1400 may be more of a stationary coupler than the first annular coupler described herein.

In an aspect, a mobile enclosure described herein may include at least six stabilizing rods coupled at junctions disposed at each of the first end of the housing and the second end of the housing of the mobile enclosure—e.g., disposed on each of the annular coupler 1380 of FIG. 13 and the second annular coupler 1400 of FIG. 14. In another aspect, a mobile enclosure described herein may include at least three stabilizing rods coupled at a junction disposed at one of the first end of the housing or the second end of the housing—e.g., disposed on the annular coupler 1380 of FIG. 13. However, in this aspect, the stabilizing rods may not include ends engaged with the second cap opposite the annular coupler 1380 of FIG. 13 (or similar), but rather the stabilizing rods may simply traverse through a second cap. Thus, in this manner, the second cap may also or instead include channels or slots through which the stabilizing rods can traverse.

FIG. 15 is a stabilizer rod for a frame of a mobile enclosure, in accordance with a representative embodiment. As shown in the figure, the stabilizer rod 1500 may include one or more hooked ends 1502 and a body 1504 between the hooked ends 1502. The hooked ends 1502 (or otherwise the ends of the stabilizer rod 1500) may be structurally configured to engage with one or more ends of a frame or housing of a mobile enclosure according to the present teachings. Specifically, the hooked ends 1502 may be structurally configured to engage with a coupler such as an annular ring or the like, such as the first annular coupler and/or the second annular coupler described above with reference to FIGS. 13 and 14, respectively. The size and shape of the hooked ends 1502 may promote securement with a coupler and/or movement when engaged with a coupler—e.g., pivotal movement that facilitates expanding and/or collapsing a frame of a mobile enclosure as described herein.

The stabilizer rod 1500 may include one or more substantially flat surfaces—e.g., the body 1504 may be relatively flat. In this manner, in an aspect, the stabilizer rod 1500 may include a relatively flat grade wire or the like (e.g., a flat flex wire or the like), which may be at least partially formed of a spring steel or the like. A length of the stabilizer rod 1500 may be about 43.70 inches long (about 11 centimeters long) in the state shown in FIG. 15. Other sizes are also or instead possible.

Thus, it will be understood that aspects of the present teachings may include a mobile enclosure that is selectively expandable (e.g., for use and enjoyment by a pet to be contained therein) and collapsible (e.g., for transport or storage). In this manner, certain aspects may include two ends, where one is relatively static, and where the other is activatable (e.g., via an actuator or the like as described herein) to promote expansion and/or collapsing of a frame of the mobile enclosure. The relatively static end may hold parts in place (e.g., fabric and metal) while the other activatable end similarly hold parts in place, but can be activated for moving the frame. In its expanded state, the mobile enclosure may resemble a sphere. In its collapsed state, the mobile enclosure may resemble a tube or cylinder.

In other aspects, one end of a mobile enclosure may incorporate a channel-over-channel design (e.g., using a material such as fabric or the like) and the other end may feature ends of stabilizing rods that are fed into one or more spring clips (e.g., three spring clips) or the like, which are then secured, e.g., via wrapping in waterproof shrink tape or the like. It will be understood, therefore, that one end of the mobile enclosure may be closed/sealed, while the other is not. Alternatively, both ends may be sealed, or both ends may be exposed. Also or instead, a non-closed/sealed end may be subsequently sealed—e.g., by placing a material such as a fabric over the end and using an adhesive, stitching, or the like to seal the end. In some implementations, one or more ends of a mobile enclosure described herein may include a cover disposed over one or more ends thereof, e.g., to create a smooth surface for the housing of the mobile enclosure, which can help promote rolling movement thereof and can mitigate snags or the like when in use.

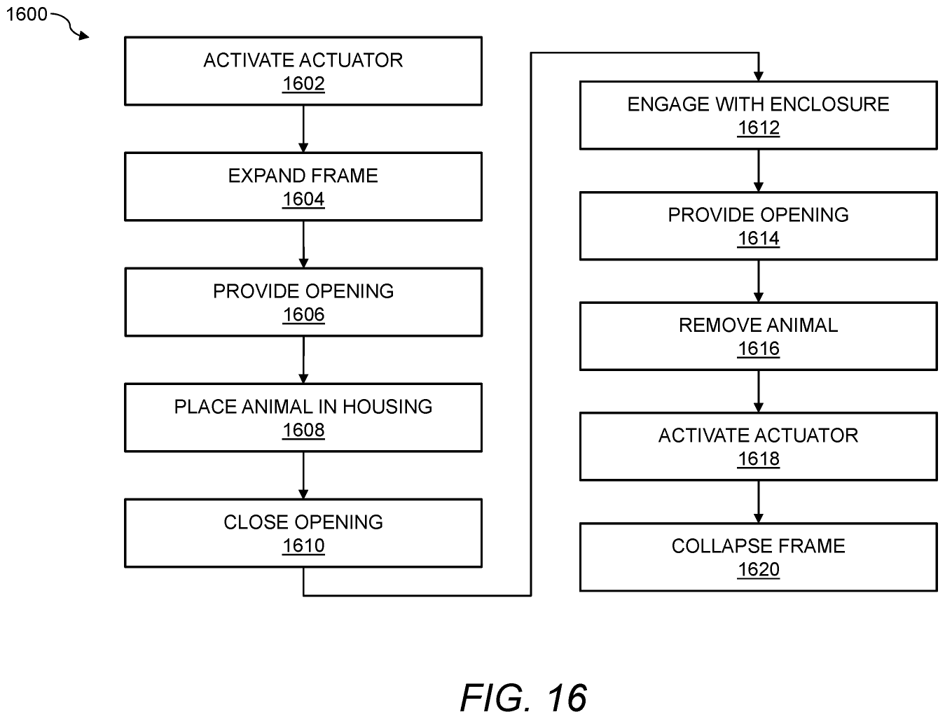

FIG. 16 is a flow chart of a method for providing a mobile enclosure for an animal, in accordance with a representative embodiment. The method 1600 may be performed using any one or more of the devices, systems, and apparatuses described herein, such as those described with reference to FIGS. 1-15.

As shown in step 1602, the method 1600 may include activating an actuator of a mobile enclosure. In particular, a mobile enclosure may be disposed within a collapsed configuration (e.g., for transport or storage), and the method 1600 may thus include activating an actuator to expand the mobile enclosure (or, more particularly, a frame thereof) for use and enjoyment. Therefore, as shown in step 1604, the method 1600 may include expanding a frame of a mobile enclosure.

In particular, in some aspects, the method 1600 may include moving an actuator of a first cap to a first position, where movement of the actuator to the first position provides a housing defining a substantially rounded shape having a diameter suitable for containing an animal therein. The housing may be any as described herein, e.g., including a plurality of panels at least one of which is gas permeable to allow smells from an external environment to be sensed by an animal from within the housing. The housing may further include a plurality of stabilizing rods arranged to maintain the substantially rounded shape of the housing when the actuator is in the first position, where each of the plurality of stabilizing rods is substantially flexible to allow for the housing to be at least partially deformed and to return to the substantially rounded shape when in use.

It will be understood that activating an actuator may thus include moving the actuator, e.g., manually. Also or instead, activating an actuator may include applying a force thereto, e.g., a pushing force. In another aspect, it will be understood that a mobile enclosure according to the present teachings may be passively expanded, e.g., without any need to activate an actuator or the like. In an aspect, one or more of expanding or collapsing of the mobile enclosure may include releasing a lock, e.g., in addition to or instead of activating an actuator.

As shown in step 1606, the method 1600 may include providing an opening in the housing, where the opening is sufficient to fit an animal therethrough. This may include engaging a fastener to provide the opening on the housing, e.g., a zipper, a button, a hook and loop closure, and/or the like.

As shown in step 1608, the method 1600 may include placing the animal within the housing through the opening. The animal may be any as described herein, e.g., a pet such as a cat or a dog.

As shown in step 1610, the method 1600 may include closing the opening. This may include engaging a fastener to close the opening on the housing, e.g., a zipper, a button, a hook and loop closure, and/or the like. Thus, step 1610 may include engaging the fastener to at least substantially close the opening.

As shown in step 1612, the method 1600 may include engaging with a mobile enclosure according to the present teachings. This may include monitoring the mobile enclosure (e.g., by watching or listening to it, and/or by tracking the mobile enclosure with an electronic device in communication with a tracker included therein or thereon).

As shown in step 1614, the method 1600 may include engaging the fastener to provide the opening on the housing. Thus, step 1614 may be the same or similar to step 1606 described above, but for removing the animal therefrom.

As shown in step 1616, the method 1600 may include removing the animal from the housing through the opening.

As shown in step 1618, the method 1600 may include activating the actuator, e.g., to collapse the housing of the mobile enclosure. In particular, this may include moving the actuator from the first position to a second position to reduce the diameter of the substantially rounded shape of the housing. Thus, in some aspects, when the actuator is in the first position, the housing is maintained in the substantially rounded shape approximating a sphere, and, when the actuator is in the second position, the diameter of the housing is reduced such that the housing approximates a cylinder. Activating the actuator may include any type of activation described herein, such as those described above with reference to step 1602.

As shown in step 1620, the method 1600 may include collapsing the frame or housing of the mobile enclosure, e.g., for transport and/or storage.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A device, comprising:
a housing configured to contain an animal therein, the housing including a plurality of panels engaged to form a substantially rounded shape having a diameter suitable for containing the animal therein, wherein at least one of the plurality of panels is gas permeable to allow smells from an external environment to be sensed by the animal from within the housing, and wherein the housing is at least partially deformable;
an opening on the housing that is selectively closable and openable via a fastener, the opening sized and shaped to receive the animal therethrough;
a plurality of channels disposed along the housing from a first end of the housing to a second end of the housing; and
a stabilizing rod disposed within each of the plurality of channels, wherein each stabilizing rod is substantially flexible to allow for the housing to be at least partially deformed and to return to the substantially rounded shape.

2. The device of claim 1, wherein each stabilizing rod includes a wire comprising spring steel.

3. The device of claim 1, wherein one or more of the first end of the housing and the second end of the housing includes a junction whereby ends of each stabilizing rod are engaged with one another.

4. The device of claim 3, wherein the junction includes a first cap structurally configured to couple with ends of each stabilizing rod via one or more connection points that selectively permit movement of the ends of each stabilizing rod, the movement facilitating deformation of the housing that reduces the diameter of the substantially rounded shape thereof.

5. The device of claim 4, wherein the movement includes rotation such that the one or more connection points comprise one or more hinges.

6. The device of claim 4, wherein the first cap includes an actuator movable between a first position and a second position, wherein, when the actuator is in the first position, the housing is maintained in the substantially rounded shape approximating a sphere, and wherein, when the actuator is in the second position, the diameter of the housing is reduced such that the housing approximates a cylinder.

7. The device of claim 6, wherein, when the actuator is in the second position, the first cap at least partially defines a void configured to receive at least a portion of material defining one or more of the plurality of panels.

8. The device of claim 6, wherein movement of the actuator includes one or more of (i) a rotation about a central axis of the housing and (ii) movement along the central axis of the housing.

9. The device of claim 6, wherein movement of the actuator causes movement of a first annular coupler comprising the one or more connection points along a central axis of the housing, and wherein movement of the first annular coupler facilitates movement of the ends of each stabilizing rod along the central axis of the housing.

10. The device of claim 4, further comprising a second cap disposed at an opposite end of the housing from the first cap, the second cap structurally configured to couple with ends of each stabilizing rod.

11. The device of claim 10, wherein one or more connection points of the second cap permit less movement of the ends of each stabilizing rod relative to the second cap compared to the selective movement permitted by the one or more connection points of the first cap.

12. The device of claim 3, wherein the junction includes one or more spring clips connecting an end of a stabilizing rod to another end of another stabilizing rod.

13. The device of claim 1, further comprising at least six stabilizing rods coupled at junctions disposed at each of the first end of the housing and the second end of the housing.

14. The device of claim 1, wherein the plurality of panels includes at least one or more first panels and one or more second panels, wherein the one or more first panels include a first material that is at least partially transparent or translucent, and wherein the one or more second panels include a second material that is substantially non-translucent.

15. The device of claim 1, further comprising a tracking device on the housing.

16. The device of claim 1, further comprising a noise emitter.

17. The device of claim 1, wherein the animal is a cat or a dog.

18. A method, comprising:
moving an actuator of a first cap to a first position, wherein movement of the actuator to the first position provides a housing defining a substantially rounded shape having a diameter suitable for containing an animal therein, the housing comprising a plurality of panels at least one of which is gas permeable to allow smells from an external environment to be sensed by the animal from within the housing, and the housing comprising a plurality of stabilizing rods arranged to maintain the substantially rounded shape of the housing when the actuator is in the first position, each of the plurality of stabilizing rods being substantially flexible to allow for the housing to be at least partially deformed and to return to the substantially rounded shape when in use;
engaging a fastener to provide an opening on the housing;
placing the animal within the housing through the opening; and
engaging the fastener to at least substantially close the opening.

19. The method of claim 18, further comprising:
engaging the fastener to provide the opening on the housing;
removing the animal from the housing through the opening; and
moving the actuator from the first position to a second position to reduce the diameter of the substantially rounded shape.

20. The method of claim 19, wherein, when the actuator is in the first position, the housing is maintained in the substantially rounded shape approximating a sphere, and wherein, when the actuator is in the second position, the diameter of the housing is reduced such that the housing approximates a cylinder.
